(19) United States
(12) Patent Application Publication
(10) Pub. No.: US 2017/0232531 A1
(43) Pub. Date: Aug. 17, 2017

(54) METHOD FOR RELOADING A SINGLE-FLUTE DRILL, AND SINGLE-FLUTE DRILL

(71) Applicant: botek Praezisionsbohrtechnik GmbH, Riederich (DE)

(72) Inventors: Joerg HILLER, Kohlberg (DE); Juergen WENZELBURGER, Metzingen (DE)

(73) Assignee: botek Praezisionsbohrtechnik GmbH, Riederich (DE)

(21) Appl. No.: 15/326,133

(22) PCT Filed: Jun. 30, 2015
(86) PCT No.: PCT/DE2015/100268

§ 371 Date: May 3, 2017

(30) Foreign Application Priority Data
Jul. 16, 2014 (DE) 10 2014 110 021.2

(51) Int. Cl. B23B 51/06; B23P 15/28

(52) U.S. Cl. CPC B23B 51/06; B23P 15/28; B23B 2215/24; B23B 2240/11; B23B 2240/21; B23B 2250/12; B23B 2251/02; B23B 2251/201; B23B 2251/422

(57) ABSTRACT

A method for reloading a single-flute drill comprising a shaft made of a hard metal and a drill head that is connected to the shaft and is made of a hard metal, is characterized by the following steps: removing a worn drill head from the shaft; integrally bonding a new drill head to the shaft.

### CROSS REFERENCE TO RELATED APPLICATIONS

This application is the National Stage of PCT/DE2015/100268 filed on Jun. 30, 2015, which claims priority under 35 U.S.C. §119 of German Application No. 10 2014 110 021.2 filed on Jul. 16, 2014, the disclosure of which is incorporated by reference. The international application under PCT article 21(2) was not published in English.

The invention relates to a method for reloading a single-flute drill and a single-flute drill.

### PRIOR ART

Deep-hole drills made of carbide are prevalent in prior art. Holes with a diameter of 0.4 to 100 millimetres can be drilled by such deep-hole drills in one stroke with a ratio of drill length to diameter of up to 150:1 and in individual cases stroke lengths up to 300 times the diameter and sometimes even into the solid, i.e. without pre-drilling. Such tools are used, for example, in engine construction, among other things, to produce fuel-injection channels in cylinder heads of combustion machines. Here, there is the demand to manufacture holes with a very small diameter and a large hole length. Very often, drilling into the solid takes place here with a high forward speed. Thus, the drill head and, in particular, the drill tip are subjected to very high loads. It thus has to have a particular wear resistance and hardness. The shaft has to have a high toughness and torsional rigidity. These requirements are met by using carbide, both for the drill shaft and for the drill head. It is thus particularly advantageously provided to manufacture the drill shaft and the drill head out of the same carbide, i.e. to manufacture the deep-hole drill as a single-piece component. Because of the high load when using this deep-hole drill, the drill heads wear down. This requires regrinding, wherein the amount of possible regrinding, however, is limited by the length of the head component, in particular, however, by the conicity of the drill head. If the minimum length of the tool is reached, the single-piece carbide component (head and shaft) has to be disposed of, which, particularly with regards to the expensive raw materials that are used for such drills and for ecological aspects, should be avoided as far as possible.

### DISCLOSURE OF THE INVENTION

### Advantages of the invention

The method for reloading such a single-flute drill and a single-flute drill having the features according to the invention have, in comparison, the advantage that worn single-flute drills made of carbide can be reloaded and their lifetime extended. In particular, such single-flute drills do not have to be thrown away if they are worn, but can at least partially be further used. The method according to the invention provides that the worn carbide head is detached from the shaft and a new carbide head is subsequently fixed to the shaft with an integral bond.

Preferred embodiments of the method are the subject matter of the sub-claims that refer back to the independent claims. In this way, it is provided in an advantageous manner that the fixing of the drill head takes place with an integral bond, preferably by soldering or adhesion.

Purely in principle, the shaft and the drill head can consist of different carbide. It is advantageously provided that the same carbide is used for the shaft and the drill head.

It is preferably provided that, after detaching the worn carbide head from the shaft, a soldering or adhesion hinge is inserted into the shaft. This can be inserted into the shaft by grinding it in, for example. At the same time, a counter-piece that is mirror-inverted relative to the soldering/adhesion hinge is provided in the drill head. Because of such a soldering or adhesion hinge, a particularly stable and secure connection of the drill head and the drill shaft is possible. The soldering and/or adhesion hinge has a substantially V-shaped form, for example, that is aligned in the axial direction, wherein the V-shaped form includes an angle of between 50° and 100°, preferably 60° and 90°. However, it is also possible to use a larger or smaller angle.

The single-flute drill according to the invention having a shaft and a drill head made of preferably the same carbide enables removing the drill head from the shaft and the new reapplication of a new drill head on the shaft. In this manner, the usability of the single-flute drill is considerably longer. A worn all-metal single-flute drill no longer has to be disposed of, but can be reused after a new drill head has been soldered to the shaft. This is not only very advantageous with regards to saving the expensive raw materials that are used for such single-flute drill, but also in particular from an ecological point of view. There is not only less waste, but considerable energy costs that are connected to the reproduction of such single-flute drills are also clearly reduced.

### SHORT DESCRIPTION OF THE DRAWING

Exemplary embodiments of the invention are depicted in the drawing.

FIG. 1 shows a schematic depiction of a single-flute drill according to the invention having a soldered clamping sleeve.

In FIG. 2, a carbide head blank is depicted which is used in the single-flute drill depicted in FIG. 1, and in

FIGS. 3a and 3b, respective front views of different exemplary embodiments of the carbide head blank depicted in FIG. 2 are depicted.

### EXEMPLARY EMBODIMENTS OF THE INVENTION

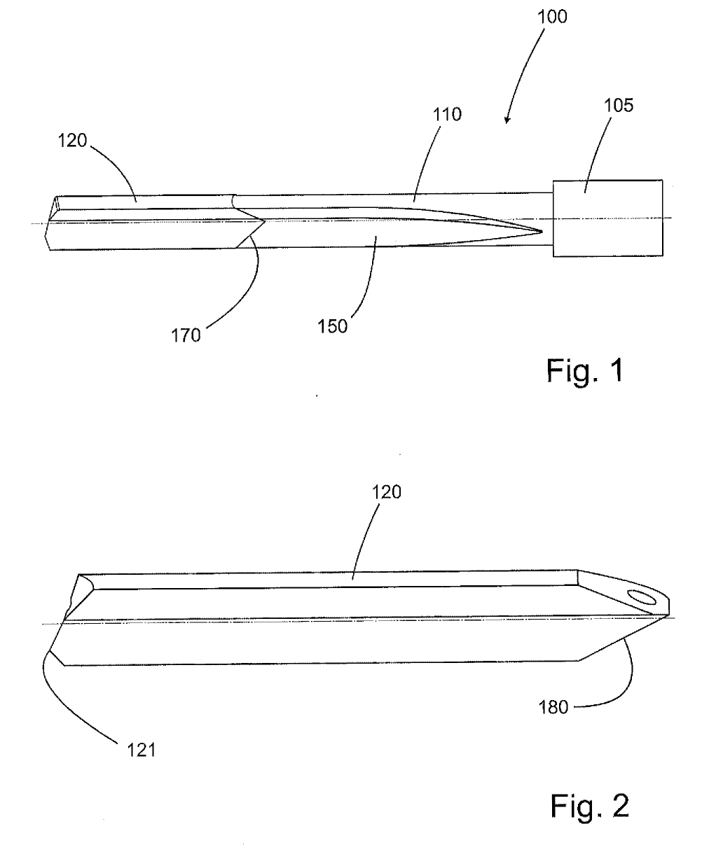

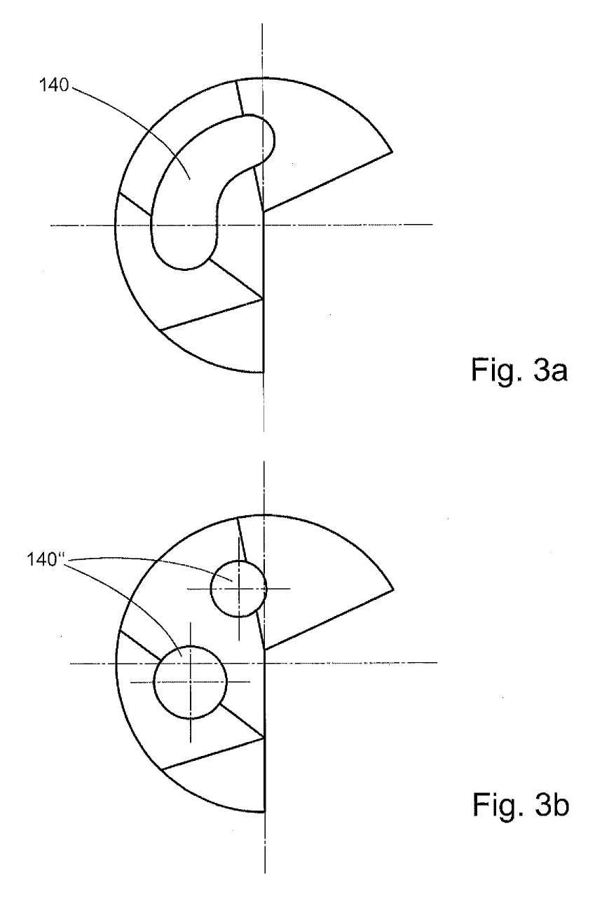

A single-flute drill 100 depicted in FIG. 1 has a clamping element 105, for example. A shaft 110, also called a drill shaft, is connected to the clamping element 105 in one piece. At this point it should be highlighted that such a clamping element 105 is optional. It is also possible to clamp an all-carbide single-flute drill directly on the shaft. A drill head 120 is connected to the drill shaft 110 in one piece, said drill head having a cutting edge on its front end. A tension nut 150 is arranged both in the shaft 110 and in the drill head 120. An inner cooling channel 140, 140″ (FIGS. 3a and 3b) is provided in the drill head 120 and in the shaft 110. The shavings produced by the metal shaving are washed out of the drill hole by the straight tension nut 10 via a cooling agent supplied with high pressure to the inner cooling channel 140, 140″. The inner cooling channel 140, 140″ can have the shape of a kidney (FIG. 3a). By doing so, a large amount of cooling agent and a good inner cooling are achieved with a negligible weakening of material. The inner cooling channel 140″ can also have a two-hole shape, as is depicted in FIG. 3b.

There are now soldered single-flute drills having a steel shaft, for example single-flute drills of the kind 110 of the applicant. All-carbide single-flute drills, for example of the kind 113 of the applicant, are used in particularly high load. Such all-carbide single-flute drills are usually implemented as a component. If the drill head is worn, it is reground. This is, however, only possible for a limited amount, since every grinding process shortens the drill head 120. When regrinding is no longer possible, the total single-flute drill becomes unusable and has to be thrown away. The method according to the invention now provides detaching the drill head 120 from the shaft 110 if it is worn, for example firstly by sawing off. After this, a soldering hinge 170 is inserted in the shaft 110. The soldering hinge 170 is inserted in the shaft 110 by grinding it in, for example. For this purpose, a mirror-inverted counter-piece 180 relative to the soldering hinge 170 is arranged in the drill head 120. Thus, the soldering hinge 170 and counter-piece 180 are formed in such a way that as large a surface as possible arises. The soldering hinge 170 and the corresponding counter-piece 180 have a V-shaped form, for example, wherein an angle of the two V-surfaces of the soldering hinge between 50⁰ and 100 are used (see FIG. 3a: 60°, FIG. 3b: 90°). The “V” is thus aligned in the axial direction with its tip pointing towards the clamping element 105.

A corresponding adhesion hinge can also be provided instead of the soldering hinge 170 having the corresponding counter-piece. In this case, the drill head 120 and shaft 110 are adhered to each other.

After this, a new drill head 120 is applied to the drill shaft 110, for example by inductive hard-soldering or adhesion. The drill head 120 and the shaft 110 are connected to each other in one piece in this way; they consist of the same carbide. The advantage of this is that the drill head 120 can be detached from the drill shaft 110 and a new drill head 120 can be newly soldered or adhered to the shaft 110. The drill head 120 is therefore connected to the drill shaft 110 with an integral bond and able to be detached. In terms of the present application, able to be detached thus means that it is once again fixed to the drill shaft 110 after removal from the drill shaft 110 and after introducing a soldering hinge/adhesion hinge into the drill shaft 110, for example by inductive hard-soldering/adhesion.

Such a single-flute drill and a method for its production are very advantageous, in particular both in terms of saving material and in terms of ecological and therefore, in the long run, economic aspects. The “lifetime” of such a single-flute drill that consists of a single carbide is thus considerably extended in this way by a removal the worn drill head 120 from the shaft 110 taking place and newly mounting a new drill head 120 on the existing shaft 110 being carried out.

1. Method for reloading a single-flute drill, comprising a shaft (110) consisting of a carbide and a drill head (120) connected to this and consisting of a carbide (120), characterised by the following steps:
detaching a worn drill head (120) from the shaft (110); and
integrally fixing a new drill head (120) to the shaft (110);
wherein a soldering/adhesion hinge (170) is inserted in the shaft after detaching the worn drill head (120) from the shaft (110).

2. Method according to claim 1, wherein the integral bonding of the new drill head (120) to the shaft (110) takes place by soldering or adhesion.

3. Method according to claim 1, wherein the same carbide is used for the shaft (110) and the drill head (120).

4. (canceled)

5. Method according to claim 1, wherein inserting the soldering/adhesion hinge (170) in the shaft (110) takes place by grinding it in.

6. Method according to claim 1, wherein a mirror-inverted counter-piece relative to the soldering/adhesion hinge (170) is provided on the new drill head.

7. Method according to claim 6, wherein the soldering/adhesion hinge (170) and the counter-piece are formed in such a way that as large a connection surface as possible arises.

8. Single-flute drill comprising a shaft (110) and a drill head (120) able to be connected to the shaft (110) by a soldering/adhesion connection releasably, wherein the shaft (110) and the drill head (120) consist of a carbide, wherein a soldering/adhesion hinge (170) is provided in the shaft (110).

9. (canceled)

10. (canceled)

11. Single-flute drill according to claim 8, wherein the soldering/adhesion hinge (170) is substantially aligned in the axial direction of the shaft (110).

12. Single-flute drill according to claim 11, wherein a counter-piece (180) that is mirror-inverted relative to the soldering/adhesion hinge (170) is provided in the drill head.

13. Single-flute drill according to claim 12, wherein the soldering/adhesion hinge (170) and the mirror-inverted counter-piece (180) are formed in such way that as large a connection surface as possible arises.

14. Single-flute drill according to claim 13, wherein the soldering hinge (170) and the counter-piece (180) have a V-shaped form having an angle of the limiting surfaces of between 50° and 100°, in particular of 60° or 90°.

15. Single-flute drill according to claim 14, wherein the shaft (110) and the drill head (120) consist of the same carbide.
